(19) United States
(12) Patent Application Publication
(10) Pub. No.: US 2020/0130707 A1
(43) Pub. Date: Apr. 30, 2020

(54) METHOD AND DEVICE FOR CHANGING A ROUTE AND/OR A DRIVING STYLE OF A VEHICLE AS A FUNCTION OF AN INTERIOR SITUATION

(71) Applicant: Robert Bosch GmbH, Stuttgart (DE)

(72) Inventors: Erich Sonntag, Marbach Am Neckar (DE); Hans-Christian Swoboda, Grossbottwar (DE); Heiko Freienstein, Weil Der Stadt (DE); Johannes Ludwig Foltin, Ditzingen (DE); Joram Berger, Weissach (DE)

(21) Appl. No.: 16/592,082

(22) Filed: Oct. 3, 2019

(30) Foreign Application Priority Data
Oct. 24, 2018 (DE) 102018218154.3

(51) Int. Cl. B60W 50/14; B60W 20/12; B60W 40/09

(52) U.S. Cl. CPC B60W 50/14; B60W 20/12; B60W 2040/0863; B60W 2050/143; B60W 40/09

(57) ABSTRACT

A method is described for changing a route and/or a driving style in a vehicle as a function of an interior situation. The method includes a step of identifying the interior situation in an interior space of the vehicle, and a step of outputting (510) a control command for controlling a vehicle in order to change the driving style and/or a route of the vehicle in response to the identified interior situation, and/or the outputting of an alarm signal in order to initiate an assumption of the vehicle control by the driver.

### CROSS REFERENCE

The present application claims the benefit under 35 U.S.C. § 119 of German Patent Application No. DE 102018218154.2 filed on Oct. 24, 2018, which is expressly incorporated herein by reference in its entirety.

### FIELD

The present invention relates to a method and a computer for changing a route and/or a driving style.

### BACKGROUND INFORMATION

Since the automotive industry is increasingly focusing on automated driving, it is advantageous to further develop existing safety standards. Until now, only general safety measures have been taken in this direction, such as a belt-reminder function, to the effect that a user of a vehicle is reminded to strap in. Although the current safety systems offer a robust and broad protective function, the relative passenger load is dependent on many parameters and differs in different seat positions so that the protective function in non-standard or novel seat positions and/or seated poses may possibly not work as well as in a conventionally provided seat position. For example, the generally modifiable protection level is dependent on the parameters of the seat position, the passenger class as well as activities and was quantified in analyses during the interior configuration process. As described below, this information may be utilized for offering more protection to the passenger, in particular during an accident.

### SUMMARY

In accordance with the present invention, a method, a device that uses this method, and finally also a corresponding computer program are provided. The measures described herein allow for advantageous further developments of and improvements in the method and the corresponding device in accordance with the present invention.

In contrast to the function of the strap-in reminder, for example, the approach introduced here serves to change a route or a driving style when an interior situation is identified that puts the vehicle passengers at risk. For example, this endangerment may be triggered by other vehicle occupants.

A method is introduced for changing a route or a driving style of a vehicle as a function of an interior situation in the vehicle, the method having the following steps:

Identifying the interior situation in an interior space of the vehicle; and outputting a control command for the control of a vehicle in order to change the driving style and/or a route of the vehicle in response to the identified interior situation, and/or outputting an alarm signal in order to trigger an assumption of the driving task of the vehicle control by the driver.

For example, a vehicle may be understood as a passenger car, a bus, a truck or the like. According to one embodiment, the vehicle may be designed to safely transport persons, for example. A driving style, for instance, may relate to the individual way in which the driver or a driver assistance system or a pilot for autonomous travel controls the vehicle. Toward this end, for example, the body posture or seated position of the driver and/or at least one passenger while driving may be taken into account. Such a pilot may thus be understood as a special case of a driver assistance system which is suitable for an autonomous vehicle control. In other words, the driver is not only assisted while driving (it is the driver who has the monitoring task) but the driver is able to attend to other matters. Because of the possible new tasks, the driver may also assume other seated positions as the case may be, which are impossible in a manual (or classically assisted) function. The term ‘interior situation’ refers to the happenings inside the vehicle, which may involve different factors. For example, this could be a conversation among several vehicle passengers, the play of children who are traveling in the vehicle, or the behavior of a pet that is also transported in the vehicle. In order to be able to identify the interior situation, it is advantageous if a detection device, which may be realized by sensors or cameras, for example, is provided in the vehicle. Depending on the interior situation, the vehicle may be able to respond appropriately when the safety of the vehicle passengers is no longer able to be ensured. This not only protects the driver and possible other passengers of the vehicle, but it may also contribute to general road safety with regard to other road users. The reaction is triggered by the output of the control command, e.g., the change in the route with regard to briefly required stopping possibilities. Other measures for changing a route or a driving style of the vehicle are also possible, such as the initiation of a braking operation or an adaptation of components in the interior space to the respective situation, which could take the form of a seat adjustment, for example.

In the step of identifying, an interaction of a driver with at least one vehicle passenger and/or an object and/or an animal is identified in one embodiment in order to allow for an identification of the interior situation. For example, this means that an unusual situation in the interior of the vehicle is able to be identified. In one embodiment, ‘unusual’ may mean the identification of any situation that endangers the safety of the vehicle passenger(s), e.g., the interaction of the driver with vehicle passengers. This avoids a distraction of the driver by other people, animals or objects. According to one embodiment, for example, a distraction may be the result of an object being dropped, a child crying, or a dog barking, but it may also be caused by conversations of other adults.

In the step of identifying, according to one embodiment of the introduced approach, a change in position of the driver is identified in order to identify the interior situation. The identification of a change in position, too, may contribute to the safety of the vehicle passengers according to one embodiment. A change in position, for example, may describe the change of a backrest of a vehicle seat of the driver or the driver bending down in order to pick up a dropped object. This may increase the risk to the vehicle passengers insofar as the protection of the vehicle passengers by an airbag in the event of an accident may not be provided to the full extent. The endangerment may relate to other road users, for instance, but also to the vehicle passengers if, for example, the driver is unable to provide an adequate response to the traffic situation for the vehicle control on account of his change in position.

According to one further embodiment of the approach presented here, an accident risk is ascertained by a step of ascertaining in response to the step of identifying. In the step of outputting, the control command may be output using the accident risk. This means that the identified interior situation is able to be evaluated, e.g., with the aid of a control device, to the effect that an accident risk is ascertainable. For instance, the accident risk may describe a probability of an accident occurring as a function of a situation. An accident may be understood as a collision of two vehicles, for example. If the accident risk is low, a different control command is therefore output than under a high accident risk. For instance, the control command may trigger a braking operation according to one embodiment.

In a step of ascertaining, an anticipated duration and/or traveled driving distance for the accident risk is/are ascertained according to one further embodiment. In the step of outputting, the control command is output using the anticipated duration and/or the traveled driving distance for the accident risk, for example. If an accident risk is identified, its anticipated duration and/or a traveled driving distance, for instance, is/are ascertained. According to one embodiment, for example, this anticipated duration and/or traveled driving distance may affect the way in which the vehicle is automatically controlled in its further movement by the output of the control command.

Alternatively or additionally, an elapsed duration and/or a traveled driving distance for the accident risk may be ascertained in the step of ascertaining. In the step of outputting, the control command will then be output using the elapsed duration and/or the traveled driving distance for the accident risk, for example. According to one embodiment, the already elapsed duration and/or the traveled driving distance of the accident risk is/are ascertained as well in order to be able to achieve a more precise reaction or control of the driving characteristics. After an existing accident risk is identified, the elapsed duration and/or the traveled driving distance of the accident risk, for example, may be realized by measuring the subsequent time and/or the driven travel distance; according to one embodiment, it may also affect the manner in which the vehicle is autonomously controlled in its further movement. One advantage when using a traveled driving distance is that it allows for a more precise specification as to how long (and thus frequently also how many possible different) traffic events may occur. Especially static events, e.g., those that are located at the side of the road such as deer crossings are able to be described quite well in this way. The use of a pure time period has advantages in particular if flowing traffic is involved because the distance is of less importance there.

Also advantageous is a specific embodiment of the presented approach in which an alarm is provided in a step of alarming in response to the step of ascertaining so that a user of the vehicle is able to be warned of the accident risk, either acoustically and/or optically. The alarm, for instance, may be output in the form of an acoustic, haptic or also an optical signal, which is meant to make the driver aware of the accident risk according to one specific embodiment. According to a specific embodiment, the driver himself may thereby have the opportunity to adapt his driving style so that no control command may possibly have to be output.

In another specific embodiment, in the step of alarming, the alarm is also able to be output in at least one of a plurality of escalation steps. Depending on the urgency of the output of the alarm, escalation steps may be differentiable based on the frequency of a signal tone or its volume, for instance. In one specific embodiment, for example, an optical, haptic as well as an acoustic alarm is able to be triggered when the duration of an accident risk increases. Because of the escalation steps according to one embodiment, the driver is able to understand that a change in driving style is becoming ever more urgent if the driving safety is to be maintained. If the driver fails to change his driving style, then a control command that triggers measures to ensure the safety is able to be output, for instance. An automatic braking operation of the vehicle, for example, may be initiated in such a case.

Also conceivable is a specific embodiment of the introduced approach in which a control command for controlling the vehicle is output in the step of outputting in response to the step of alarming if no further change in the interior situation as a reaction to a provided alarm is identified. For example, the further change in the interior situation may be made by vehicle passengers. When the passenger changes back to his initial position, for instance, the identified accident risk may drop because the passenger is better able to control the vehicle in this position, and/or protection means may have a better effect during an accident. On the other hand, a control command will be output if the driver stays in the identified position. How quickly and after how much time the control command is triggered may depend on the level and the duration of the accident risk and the resulting urgency of an intervention, for example. In addition, for instance, the situation- and time-dependent interventions on the part of the vehicle may have the advantage that the driver will not feel disturbed. In addition to an improved initial position in the event of an accident, it is particularly also possible that the driver is more rapidly able to assume control of the vehicle in his improved initial position, which may be advantageous especially in the case of automated vehicles or pilots, for example.

In one specific embodiment, in the step of outputting, a first control command is output when a first accident risk exists, and/or a second control command is output when a second accident risk exists, the second accident risk being greater than the first accident risk. In one specific embodiment, for example, an alarm may be triggered following an increase in the accident risk, whereupon the vehicle passengers may remedy the cause of this increase. However, if a comparable or more serious situation occurs that increases the accident risk anew and triggers another alarm after a brief period of time, then the control command is able to be output more quickly. This not only gives the driver time to react on his own, but it also ensures that his safety and the safety of other road users is prioritized.

The method introduced here is able to be implemented in software or hardware, for example, or in a mixed form of software and hardware such as in a control unit.

The introduced approach also provides a control unit, which is developed to carry out, actuate or implement the steps of a variant of the method introduced here in corresponding devices. This variant of an embodiment of the present invention in the form of a control unit also makes it possible to achieve the objective on which the present invention is based in a rapid and efficient manner.

Toward this end, the control unit may include at least one processing unit for processing signals or data; at least one memory unit for storing signals or data; at least one interface to a sensor or an actuator for reading in sensor signals from the sensor or for outputting control signals to the actuator; and/or at least one communications interface for reading in or outputting data which are embedded in a communications protocol. For example, the processing unit may be a signal processor, a microcontroller or the like, and the memory unit may be a flash memory, an EEPROM or a magnetic memory unit. The communications interface may be developed to read in or output data in a wireless and/or wire-conducted manner, a communications interface that may read in or output wire-conducted data being able to read in these data, e.g., electrically or optically, from a corresponding data transmission line or to output it onto a corresponding data transmission line.

In this context, a control unit may be understood as an electrical device that processes sensor signals and outputs control and/or data signals as a function thereof. The control unit may have an interface that could be developed in hardware and/or software. In a hardware development, the interface may be part of what is known as a system ASIC, for example, which encompasses a wide variety of functions of the control unit.

However, it is also possible that these interfaces are discrete integrated switching circuits or are at least partially made up of discrete components. In a software development, the interfaces may be software modules which are provided on a microcontroller in addition to other software modules, for example.

In one advantageous specific embodiment, the control unit controls an autonomous driving system. Toward this end, the control unit may access sensor signals such as image signals, for instance. The actuation takes place via actuators such as a brake and/or an engine control unit, for instance. In automated vehicles with pilot systems on board, the driver is able to transfer the responsibility to the vehicle and the vehicle takes over the vehicle control function (AD mode). For the most part, the approach presented here is used to reduce the accident risk in the AD mode in that the vehicle changes the driving style and/or the route depending on the respective situation.

Also advantageous is a computer program product or a computer program having program code, which may be stored on a machine-readable carrier or memory medium such as a semiconductor memory, a hard disk memory or an optical memory and which is used for executing, implementing and/or actuating the steps of the present method as recited in one of the afore-described specific embodiments, in particular when the program product or the program is executed on a computer or a device.

Exemplary embodiments of the approach presented here are illustrated in the figures and described in greater detail below.

### BRIEF DESCRIPTION OF THE DRAWINGS

FIG. 1 shows a sketch-like illustration of an interior situation including a control unit according to an exemplary embodiment.

FIG. 2 shows illustrations of different interior situations to be identified according to an exemplary embodiment.

FIG. 3 shows a risk-time diagram for determining a change in a route and/or driving style of a vehicle to be used in an exemplary embodiment.

FIG. 4 shows a flow diagram for determining the required reaction as a function of the duration of the risk exceedance for use in an exemplary embodiment.

FIG. 5 shows a flow diagram of a method according to an exemplary embodiment.

### DETAILED DESCRIPTION OF EXAMPLE EMBODIMENTS

In the following description of advantageous exemplary embodiments of the present invention, the same or similar reference numerals have been used for the elements that are shown in the various figures and have similar effects, and a repeated description of these elements is dispensed with.

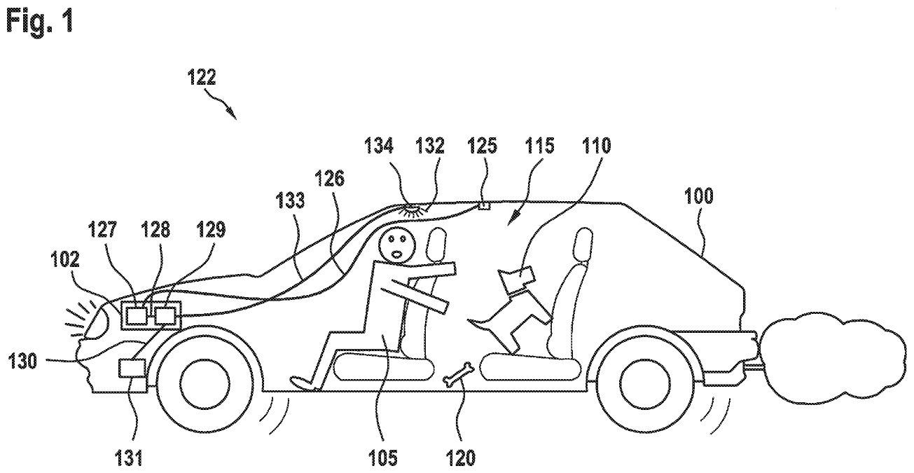

FIG. 1 shows a sketched illustration of an interior situation of a vehicle 100 having a control unit 102 according to an exemplary embodiment. Vehicle 100 is able to transport passengers, for example. In addition to a driver 105, a further passenger 110 such as in the form of a dog may be present in interior 115 of vehicle 100. According to one exemplary embodiment, passenger 110 may distract driver 105 from driving, for example by barking or by a dropped object 120. This increases an accident risk if the driver tends to the further passenger 110, i.e., the dog in this instance, instead of focusing on the traffic situation in vehicle environment 122. The example of an interior situation 115 according to an exemplary embodiment illustrated in FIG. 1 shows that driver 105 of vehicle 100 turns back to passenger 110 and is thereby distracted. In order to allow for the identification of the accident risk based on interior situation 115, a detection device 125 may be provided on or inside vehicle 100. For example, detection device 125 may be realized in the form of sensors or cameras. Detection device 125, for instance, is able to output a detection signal 126 to an identification unit 127, in which interior situation 115 is identified or evaluated or extracted from detection signal 126. An identification signal 128 that represents interior situation 115 will then be generated in detection device 125 and sent to an output unit 129, which outputs a control command 132 in response to identified interior situation 115, e.g., to a driver assistance system 131, which is able to initiate or activate an automatic braking operation or a lane-keeping function of vehicle 100. If interior situation 115 was classified as risky, then an alarm 132 to an alarm unit 134 may additionally be triggered with the aid of an alarm signal 133, which may be of an optical (as illustrated in FIG. 1), haptic and/or acoustic nature according to one exemplary development, or which is able to be triggered in a plurality of different escalation stages before vehicle 100 or driver assistance system 131 initiates countermeasures. This offers the advantage that in the presence of an incorrect behavior, driver 105 is able to detect the escalation stages in the form of time steps and may react appropriately. In addition, the driving comfort may gradually drop until a safe driving style is achieved. In one exemplary embodiment, the alarm may alternatively also occur in combined form in that, for example, a first alarm 132 and then a further alarm 132 are activated or both alarms/alarm types occur simultaneously.

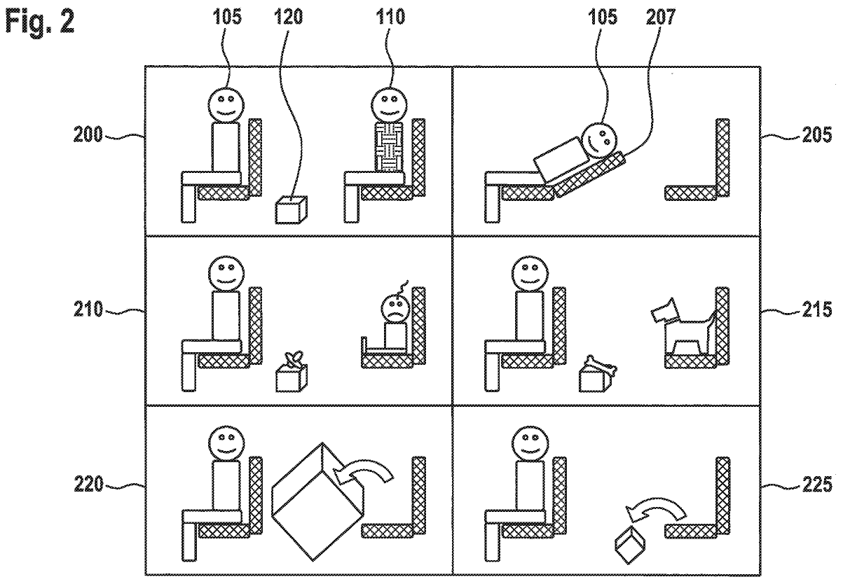

FIG. 2 shows six illustrations of different interior scenarios 200, 205, 210, 215, 220, 225 according to different exemplary embodiments that illustrate interior scenario 115 shown in FIG. 1. These situations may thus occur in a vehicle as shown in FIG. 1. In a first situation 200, driver 105 and a further passenger 110, e.g., a further adult, are located inside the vehicle in which an object 120 has been dropped according to an exemplary embodiment. The accident risk rises in situation 200, e.g., when driver 105 himself attempts to pick up object 120 while driving, so that a control command for the control of the vehicle is output. However, if driver 105 asks passenger 110 to retrieve the object, for instance, then the accident risk remains low.

In a second situation 205, driver 105 is alone inside the vehicle but his backrest 207 is in a very flat, virtually horizontal position, which increases the accident risk so that the control command is output, for instance in order to reset backrest 207 of the vehicle and/or to induce the passenger to reset backrest 207 of the vehicle, e.g., by way of a message and/or an alarm signal.

Third situation 210 and fourth situation 215 are similar to situation 200 insofar as passenger 110 and object 120 are likewise located in the interior of the vehicle. According to an exemplary embodiment, passenger 110 could be a child or an animal, which has dropped its pacifier or bone as the case may be. Similar to first situation 200, driver 105 may be distracted so that the accident risk increases.

In fifth situation 220 and sixth situation 225, as well, an object 120 has also been dropped according to an exemplary embodiment. Whereas a large object 120 is shown in fifth situation 220, e.g., a beverage crate, a small object 120, which falls from a rear set and thereby draws the attention of driver 105, is shown in sixth situation 225.

Interior situations 200, 205, 210, 215, 220, 225 shown in FIG. 2 all have in common that the accident risk may increase if driver 105 of the vehicle responds to situations 200, 205, 210, 215, 220, 225 on his own while driving. For example, if several adults are in the vehicle, a greater adaptation of the driving style may be preferred when an adult turns back, and a slighter adaptation may be preferred if an adult only bends forward. This means that the wait time for a small adaptation to a great adaptation is reduced if several adults are present and a turning around motion occurs.

If the person moves to a more comfortable position “for no reason” (and without passengers), then a route or a driving style of the vehicle is immediately adapted with the aid of the control command, for example. When a child or an animal is on the rear seat (more generally, if the adult turns around to the child/animal), then only a slight adaptation of the driving style is made and/or a stopping possibility (route adaptation for the search for a parking spot or simply for a stop along the side) is already looked for at the same time. If a stopping possibility is available, the driver will be informed, who may (optionally) confirm the stop. The reason for this is that the driver sometimes finds it difficult to attend to a whining child (which has lost its pacifier, for instance) or to a nervous animal from the front. If the cause is quickly resolved (e.g., the toy is quickly picked up again), then the slight reaction with respect to a change in the driving style and/or a route of the vehicle will be sufficient. More thorough “attention”, however, usually necessitates a stop of the vehicle. This means that when the cause cannot be remedied within a certain period of time (e.g., the toy is just outside the reach of the driver), a stop will be made. If an additional passenger on the rear seat could take care of the cause of the changed interior situation, then only a slight adaptation of the driving style is able to take place, whereas a stronger adaptation of the driving style is implemented or the wait time for increasing the adaptation of the driving style is decreased, e.g., when the driver turns back. This offers the advantage that next time, the driver may ask for assistance from the passenger, who does not have to turn around. An adaptation from a slight to a greater change in the driving style or the route of the vehicle takes place after a predefined period of time, for example.

If a large object has dropped on the floor of the vehicle, then the driver will be unable to pick it up without stopping the vehicle. This means an adaptation of the driving style, e.g., a search for a parking spot. A strong reaction by the change in driving style or the route of the vehicle takes place right away, no long reaction time being desired.

On the other hand, if a smaller object has dropped on the floor of the vehicle and no other passenger is present in the vehicle, then the driving style will be adapted more strongly only after a certain wait time, for example, or an opportunity for a stop is offered as a change in the route so that the driver will have the chance to retrieve the object.

In one form of the introduced approach, for instance, a visual notification is first output to the driver, followed by a slight adaptation of the driving style, whereupon a strong adaptation of the driving style takes place, e.g., if an accident risk steadily increases. An acoustic signal may optionally be output in such a case. This offers the advantage that if an incorrect behavior occurs, the passenger is able to feel the escalation steps in the form of time steps (and may react accordingly) and the driving comfort or the driving style gradually decreases. In addition, this is advantageous for the surrounding traffic insofar as the parties involved in the traffic situation may become fully aware of the behavior of the autonomously driving vehicle, which normally means a reduction in the vehicle speed of these road users, for instance.

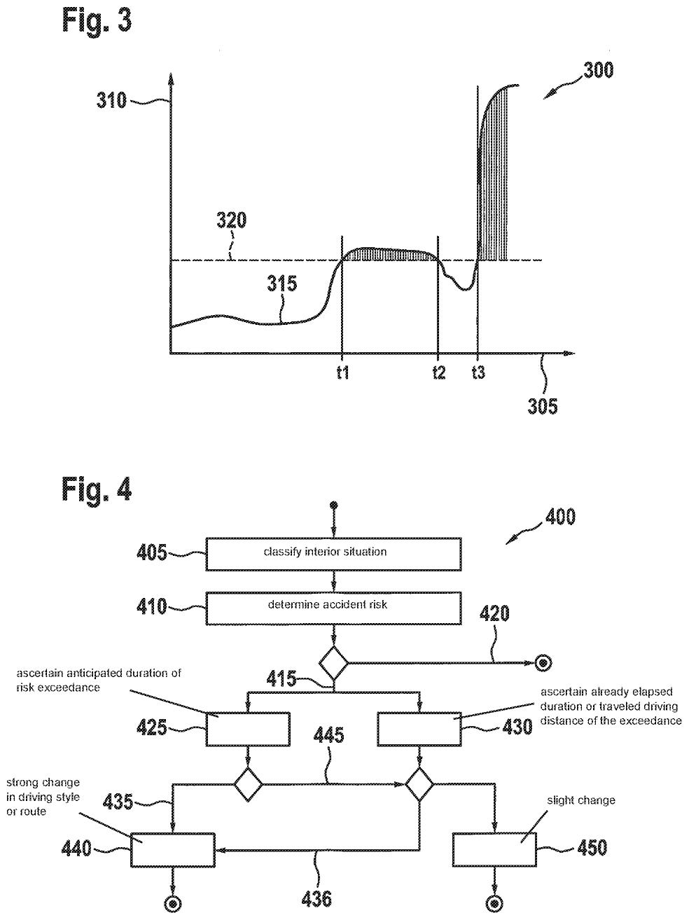

FIG. 3 shows a risk-time diagram 300 according to an exemplary embodiment. Diagram 300 is made up of an x-axis 305 on which a duration of the accident risk and the reaction time of the vehicle have been plotted. A y-axis 310 symbolizes an accident risk degree or an exceeding of an accident risk threshold. A curve 315 describes the characteristic of the accident risk in terms of its duration and its degree. To ensure that the output of the control command does not occur arbitrarily, a threshold value 320 is defined in advance according to one exemplary embodiment, which—once the accident risk degree has been exceeded—allows for the output of a control command. If the accident risk remains below threshold value 320, for example, no measures will be initiated. If the accident risk rises beyond this threshold value 320, then the control command is output and measures are initiated. According to one exemplary embodiment, however, a distinction is made as to how strongly or for how long the accident risk lies above threshold value 320. In FIG. 3, for instance, the instant of the first exceeding of threshold value 320 is denoted by t1. Instant t1 may represent the moment when the driver of the vehicle according to the illustration in FIGS. 1 and/or 2 bends down in order to pick up the dropped object, for example. Instant t2, for example, may represent the moment when the driver in FIG. 1 or 2 concentrates on the driving task again, so that a degree of the accident risk drops below threshold value 320 again. At instant t3, the accident rises drastically according to an exemplary embodiment because the driver takes off the seat belt, for example, since the original problem has not been remedied. A faster response by a countermeasure is possible in such a case, which means that the control command for actuating the vehicle is output more rapidly, e.g., in the form of a braking operation. Put another way, at a great risk exceedance, a faster reaction is possible than at a slight exceedance. The magnitude of the exceeding of the accident risk degree is able to be calculated in an algorithm as an integral (“area”) of the risk exceedance over the time.

For instance, the environment or the traffic situation around the vehicle, in particular, may have a considerable influence on the reaction or the time period until a system reaction occurs by the driver assistance system, for example. If barely any other road users are present, and with large gaps between vehicles and/or low relative speeds between the vehicles that are part of the traffic scenario, a system reaction by the driver assistance system may occur considerably later than in the case of dense traffic, small gaps between vehicles and/or high relative speeds between vehicles. This means that in addition to the potential injury severity (in particular caused by the interior situation and the relative speed), the accident probability may also play a role in connection with the output of the control command.

For example, the driver turns back at instant t1 in order to pick up a dropped toy. This raises the accident risk beyond the risk limit, i.e. threshold value 320. At instant t2, the driver, for example, is acoustically informed of the disadvantageous behavior with regard to the traffic safety of the vehicle, and the driver turns back to the front again and/or the speed is reduced, in which case the accident risk drops below threshold value 320 once again. At instant t3, the accident risk increases drastically, for instance because the driver unbuckles the seat belt since the original problem has not been resolved. Now, the reaction is faster than at instant t1 on account of a high accident risk. This may be gathered from the hatched area under the curve of FIG. 3, which is considerably larger than the area that follows the exceeding of threshold value 320 at instant t1. The integral of the risk increase between instant t1 and instant t2 is lower than between instant t3 and instant t4. At instant t4, the risk integral rises beyond the tolerable area so that a more drastic measure is taken by the output of the control command, e.g., a transfer of the driving responsibility to the driver including the initiation of a possible emergency stop.

As long as the increase in risk lies within a tolerable range (i.e. the integral area is relatively small, for instance), different countermeasures are able to be taken through the output of a corresponding control command in an effort to move the accident risk below the risk limit, i.e. threshold value 320. For example, this may include the sounding of an acoustic signal or an alert that begins at a first risk-area threshold, a moderate adjustment of the driving style starting at a second threshold until the risk is able to be reduced before a third threshold is reached through a route adaptation (e.g., the output of a control command to head for a parking spot). If the third threshold is reached (for example, at instant t4 in FIG. 3), then the driving style is able to be adapted more strongly (e.g., the driving may be slowed down considerably), and/or a transfer of the driving responsibility to the driver is initiated in order to lower the accident risk below the risk limit or threshold value 320 (for a certain period of time).

Depending on the individual details, the area below curve 315 between instant t1 and instant t2 may be added to the area below curve 315 between instant t3 and t4, provided instant t1 and instant t4 are not too far apart (the area below curve 315 between instant t1 and instant t2 may then be considered not to be outdated yet), and/or the distance between instant t2 and t3 may be considered to be small enough. For instance, this prevents the consideration of noise around the risk limit or threshold value 320 with only brief drops below threshold 320 and a higher risk integral from being produced by combining the areas interrupted by noise, so that a timely reaction is possible.

A similar behavior could be achieved if a (sufficiently large window) integral is used for determining the areas below curve 315.

FIG. 4 shows a flow diagram of a method 400 for determining the required reaction or the output of the control command according to an exemplary embodiment as a function of the duration of the risk exceedance or the exceeding of curve 315 beyond threshold value 320. In a step of classifying 405, the interior situation is classified. This means that the interior situation is identified as a first step, which may be accomplished using a camera, before the control command is able to be output. In order to output the control command, for example, a plurality of stages is cycled through, which are linked to conditions according to one exemplary embodiment. For example, the step of classifying 405 is followed by a step of determining 410 the accident risk. If there is an accident risk or if the accident risk lies above threshold value 320 as described in FIG. 3, an ascertainment signal 415 will be output. If no accident risk exists or if it lies below threshold value 320, then method 400 will be terminated via a termination signal 420.

Ascertainment signal 415, for example, triggers two steps of ascertaining 425 and 430. In the first step of ascertaining 425, the anticipated duration of the risk exceedance is ascertained. If an anticipated long duration was ascertained, then a first control command 435 is output, which initiates a step of a strong change 440 in the driving style or the route. If the ascertained duration is expected to be short, then a second control command 445 is output, which triggers a step of a slight change 450.

In second step 430, the already elapsed duration and/or the traveled driving distance of the risk exceedance is/are ascertained. If the already elapsed duration and/or the traveled driving distance is/are long, then a control command 436 which triggers the step of a strong change 440 is output. It could therefore be said that when it has to be assumed that the interior situation is only of a short duration, a slight/small adaptation of the driving style may be undertaken. If it has to be assumed that the interior situation will last longer, then an adaptation of the interior (seat adjustment) may be carried out, for example, and/or the driving style may be adapted more drastically (e.g., a considerable speed reduction). If an interior situation that was assumed to be of a short duration will then take longer after all, stronger measures are also initiated, e.g., an adaptation of components in the interior, the driving style and also an adaptation of the route of the vehicle (in particular heading for a parking space).

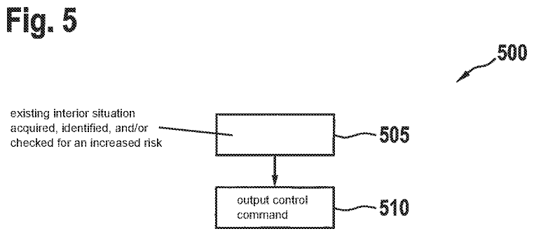

FIG. 5 shows a flow diagram of a method 500 according to an exemplary embodiment. The flow diagram corresponds to the flow diagram illustrated in FIG. 4, and it is shown reduced to the essential steps. According to an exemplary embodiment, in the steps of identifying 505, the existing interior situation may be acquired, identified and/or checked for an increased accident risk. For example, this means that both the seated position of the driver and a distraction of the driver by passengers or by dropped objects are able to be identified according to one exemplary embodiment.

In the step of outputting 510 a control command, a control signal is output, which induces the vehicle to start with the change in driving style and/or the route, e.g., with the aid of a control unit. As an alternative, the control command according to an exemplary embodiment may relate to the interior of the vehicle to the effect that the seated position of the passengers is modified, for instance. In the step of outputting 510, an alarm signal may alternatively or additionally be output in order to initiate the assumption of the driving task of the vehicle control by the driver. In other words, it may be said that when it has to be assumed that the interior situation will only be of a short duration, for instance, a slight or small change in the driving style may be undertaken. When it has to be assumed that the interior situation will last longer, for example, then a change in the interior may take place and/or the driving style may be modified to a greater degree.

If an exemplary embodiment includes an ‘and/or’ linkage between a first feature and a second feature, then this should be read to imply that the exemplary embodiment according to one specific embodiment includes both the first and the second feature, and according to a further specific embodiment, includes either only the first feature or only the second feature.

What is claimed is:

1. A method for changing a route and/or driving style of a vehicle as a function of an interior situation in a vehicle, the method comprising the following steps:
identifying the interior situation in an interior space of the vehicle; and
outputting a control command for the control of the vehicle to, in response to the identified interior situation: (i) change the driving style, and/or change a route of the vehicle, and/or (ii) output an alarm signal to trigger an assumption of a driving task of vehicle control by a driver of the vehicle.

2. The method as recited in claim 1, wherein, in the identifying step, an interaction of a driver with” (i) at least one vehicle passenger, and/or (ii) an object, and/or (iii) an animal, is identified to identify the interior situation.

3. The method as recited in claim 1, wherein in the identifying step, a change in position of the driver is identified to identify the interior situation.

4. The method as recited in claim 1, further comprising:
ascertaining, in response to the identifying step, an accident risk, wherein in the outputting step, the control command is output using the accident risk.

5. The method as recited in claim 4, wherein in the ascertaining step, an anticipated duration and/or a traveled driving distance for the accident risk, is ascertained, and in the outputting step, the control command is output using the anticipated duration and/or the traveled driving distance for the accident risk.

6. The method as recited in claim 4, wherein, in the ascertaining step, an elapsed duration and/or the traveled driving distance for the accident risk, is ascertained, and in the outputting step, the control command is output using the elapsed duration and/or the traveled driving distance for the accident risk.

7. The method as recited in claim 4, further comprising
alarming, in response to the ascertaining, a user of the vehicle, the alarming including alarming the user acoustically, haptically, and/or optically about the accident risk.

8. The method as recited in claim 7, wherein, in the alarming step, the alarm is output in at least one of a plurality of escalation steps.

9. The method as recited in claim 7, wherein in the outputting step, in response to the step of alarming, the control command for controlling the vehicle is output if no further change in the interior situation in response to the provided alarm is identified.

10. The method as recited in claim 4, wherein in the outputting step, a first control command is output when a first accident risk exists, and/or a second control command is output when a second accident risk exists, the second accident risk being greater than the first accident risk.

11. A control unit for changing a route and/or driving style of a vehicle as a function of an interior situation in a vehicle, the control unit configured to:
identify the interior situation in an interior space of the vehicle; and
output a control command for the control of the vehicle to, in response to the identified interior situation: (i) change the driving style, and/or change a route of the vehicle, and/or (ii) output an alarm signal to trigger an assumption of a driving task of vehicle control by a driver of the vehicle.

12. A non-transitory machine-readable memory medium on which is stored a computer program for changing a route and/or driving style of a vehicle as a function of an interior situation in a vehicle, the computer program, when executed by a computer, causing the computer to perform the following steps:
identifying the interior situation in an interior space of the vehicle; and
outputting a control command for the control of the vehicle to, in response to the identified interior situation: (i) change the driving style, and/or change a route of the vehicle, and/or (ii) output an alarm signal to trigger an assumption of a driving task of vehicle control by a driver of the vehicle.
